(19) United States
(12) Patent Application Publication
(10) Pub. No.: US 2005/0181813 A1
(43) Pub. Date: Aug. 18, 2005

(54) Signal path selection process in cellular network architecture

(76) Inventor: Jialin Zou, Randolph, NJ (US)

Correspondence Address: Michael G. Gletcher;Fletcher Yoder, P.O. Box 692289, Houston, TX, 77269-2289, US

(21) Appl. No.: 10/777,499

(22) Filed: Feb. 12, 2004

(51) Int. Cl. H04B 7/00

(52) U.S. Cl. 455/513

(57) ABSTRACT

A reverse link searcher to determine a signal path from multiple signal paths is shown. A reverse link searcher orders signal energies based on the strength of the signal energies and creates candidate signal lists that are each associated with one antenna. Also, the reverse link searcher orders signal energies in a candidate signal lists and creates a path selection list based on the strength of the signal energies in the candidate signal lists. This technique allows comparison operations to be minimized to reduce the processing time for a signal path selection.

### BACKGROUND OF THE INVENTION

1. Field of the Invention

The present invention relates generally to telecommunications and, more particularly, to wireless communication systems.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Over the past decades, wireless communication systems, sometimes referred to as mobile telephone systems or cellular telephone systems, have continued to evolve. Although the first mobile telephone system for the public was introduced in 1946, and improved in 1965, modern wireless technology was introduced in 1970 as advanced mobile phone service (AMPS), which became America's analog cellular standard. From the AMPS system, various digital wireless systems developed, such as personal communication services (PCS), which were introduced in the mid-1990s as a second-generation wireless service. From the PCS systems, other technologies developed to increase the quality and capacity of the systems, such as time division multiple access (TDMA), frequency division multiple access (FDMA), code division multiple access (CDMA), and Global System for Mobile Communications (GSM).

The current development of the 3^{rd} generation or “3G” wireless standards including CDMA2000, UMTS and TD-SCDMA is moving toward to support multi-media applications with mixed traffics (from voice to high speed data) in both forward link and reverse link. These 3G standards are evolved from 2G systems with their air interface employing fundamentally the same technology—CDMA.

With wireless communications systems, the limited number of radio frequencies available for wireless service were “stretched” by scattering multiple lower-powered transceivers throughout a metropolitan area and by “handing off” calls from one transceiver to another as customers move around in the area. In other words, each transceiver defined a “cell” that communicates with the customer's cellular telephone. As the customer moves from one cell to another, the customer's cellular telephone communicates with different transceivers to maintain the wireless connection.

In any given cellular market, such as a typical metropolitan area, a wireless communication system, or cellular network, typically includes multiple base stations that are distributed throughout the market. The base stations serve the wireless communication system, and perform the functions of switching calls to the appropriate destination and maintaining the connection with the various wireless customers. As such, the typical base station may include a number of systems or components that control switching functions, call processing, channel assignments, data interfaces, tracking, paging, call hand-off, billing, and user databases. The typical base station may include a radio tower, antennas, cables, equipment, such as a baseband system and a radio frequency (RF) system, and a cabinet that houses the equipment. In addition, the base stations are typically coupled to the public switch telephone network (PSTN), which is often referred to as a land-based telephone network. The connection to the PSTN allows the cellular telephone calls to be communicated with landline telephones or other wireless networks through the PSTN.

As can be appreciated, a typical cellular customer may be passed from cell to cell in a cellular network, which depends on the movement of the customer and limited space that each cell may cover in densely populated area. As a result, base stations may have to hand off the connection to a wireless customer to another antenna within the base station or to another base station based on the signal path that has the strongest signal with the wireless customer. Because the number of frequencies and associated signal strengths are analyzed for a group of antennas, the computations involved with determining which signal path to choose becomes increasingly complex. As the complexity of the computations increases, it becomes increasingly difficult to calculate the signal strengths in the time provided for certain technologies, such as CDMA.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, a wireless communications system is provided. The wireless communications system includes a device for searching signal paths. As set forth by way of example, the device includes a first stage that sorts signal energies into an ordered candidate signal list for each of a group of antennas. The signal energies are sorted based on the strength of the signal energies. In addition, the device includes a second stage that sorts the ordered candidate signal lists into a signal path list. The signal path list is also sorted based on the strength of the signal energies in the ordered candidate signal lists.

### BRIEF DESCRIPTION OF THE DRAWINGS

Advantages of the invention may become apparent upon reading the following detailed description and upon reference to the drawings in which:

FIG. 1 illustrates an exemplary embodiment of a wireless communications system having a base station and wireless units;

FIG. 2 illustrates an exemplary embodiment of a base station having a distributed RF system within the wireless communications system of FIG. 1;

FIG. 3 illustrates the sorting of signal energies in an exemplary embodiment the first stage of the reverse link searcher unit in FIG. 2; and

FIG. 4 illustrates the sorting of signal energies from various antennas in an exemplary embodiment the second stage of the reverse link searcher unit in FIG. 2.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions should be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As part of the current move to develop 3G standards for wireless technology, various technologies and standards are being developed to evolve to next generation of wireless system. These technologies may include time division multiple access (TDMA), code division multiple access (CDMA), and Global System for Mobile Communications (GSM). Specifically, with regard to the CDMA technology, one such standard under development is the CDMA2000 Standard, which includes an Upper Layer (Layer 3) Standard for cdma2000® Standard for cdma2000 Spread Spectrum Systems, a G3G CDMA-DS to ANSI/TIA/EIA-41, IS-41-C Enhancements for PCS Multi-Band Support Standard, and a CDMA 2000® Series, which are hereby incorporated by reference. These CDMA2000 standards correspond to the communications between a wireless unit and a base station, within the base stations, and between different base stations.

The techniques disclosed herein provide an improved approach for calculating signal paths for a wireless unit. Specifically, the techniques described herein utilize a reverse link searcher unit to analyze signal energies from different antennas to determine the largest signal energies for a wireless connection. Under the present technique, the reverse link searcher unit may include a first stage that sorts the signal energies associated with each of the antennas to create a list of candidate signal paths for each of the antennas. The first stage may include a first algorithm, such as an “n” out of “N” heapsort algorithm, that is utilized to optimize the ordering of a block of signal energies associated with an antenna. In addition, the reverse link searcher unit may include a second stage that sorts the list of candidate signal paths into a signal path list, which include the optimal signal paths for the wireless connection. The second stage may include a second algorithm, such as a “two-level grouping” sorting algorithm, which optimizes the sorting of the ordered candidate signal paths into the signal path list. This technique performs the searching operations over ten times faster than a one-to-one comparison method. As a result, the reverse link searcher unit may reduce the processing time by reducing the number of comparison operations utilized to determine the optimal signal path.

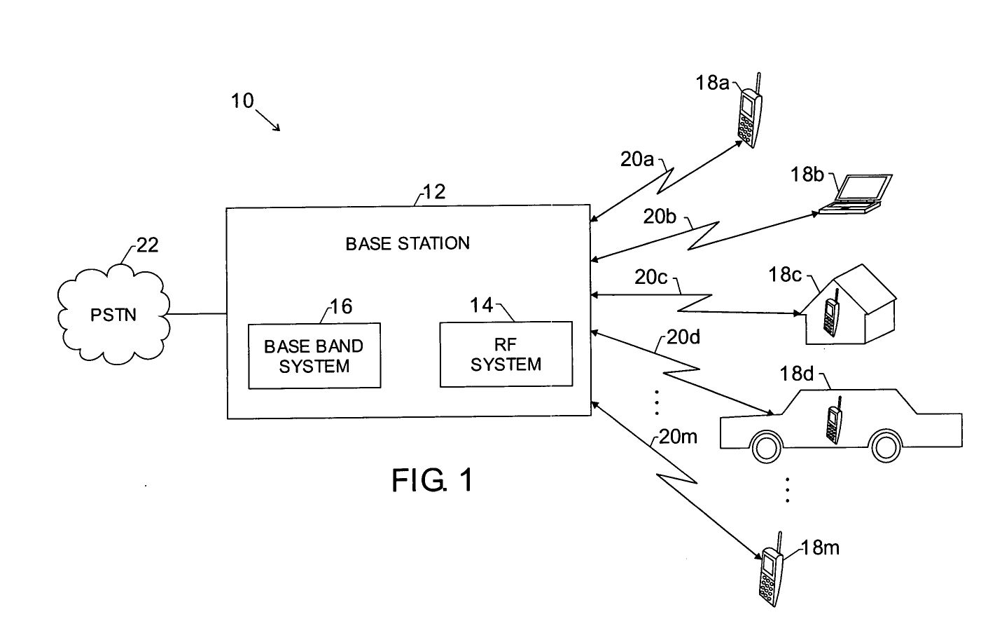

Turning now to the drawings, and referring initially to FIG. 1, an exemplary wireless communications system that incorporates a base station and wireless units is illustrated and generally referred to by reference numeral 10. In any given cellular market, such as a typical metropolitan area, a cellular network, such as the wireless communications system 10, may include one or more base stations 12. The base station 12 communicates with wireless units 18ₐ-18ₘ via signal paths 20ₐ-20ₘ. The reference character “m” may correspond to the number of wireless units or signal paths that are associated with the base station 12. By analyzing the signal paths 20ₐ-20ₘ, the base station 12 may perform a path selection process to switch calls between antennas and to maintain the connection with the wireless units 18ₐ-18ₘ.

The base station 12 may take any suitable form. For example, the base station 12 may include a radio frequency (RF) system 14 and a baseband system 16. The RF system 14 typically includes antennas and transceivers (sometimes called base station radios) that communicate with wireless units 18ₐ-18ₘ over the signal paths 20ₐ-20ₘ. The wireless units 18ₐ-18ₘ may be any suitable communications device that may communicate voice, video and/or data, such as portable cellular telephones 18ₐ and 18ₘ, a computer system having wireless modem 18_{b}, a cellular telephone in a building 18_{c}, and/or a vehicle having mobile cellular telephone and/or navigation system 18_{d}.

The baseband system 16, on the other hand, typically includes a processor that handles communication between the RF system 14 and switching devices in a Public Switched Telephone Network (PSTN) 22. The base station 12 is typically coupled to the PSTN 22 through the baseband system 16. A typical wireless communications system 10 includes a connection to the PSTN 22 because a majority of all wireless telephone calls pass through the PSTN 22. The PSTN 22 may include additional switches and equipment to perform certain functions, such as routing of connections, control switching functions, call processing, data interfacing, tracking, paging, call hand-off, billing, and storing of user data.

The RF system 14 in the base station 12 may either be a distributed or centralized system. Within the RF system 14, each transceiver may be coupled to an antenna to form a RF subsystem. In a centralized RF system 14, RF subsystems may be located in the same location as the baseband system 16. The systems 14 and 16 may be coupled together via a network that may include standard twisted pair, fiber optics, copper, or other suitable networks, for example. In a distributed RF system 14, the RF subsystems may be placed in multiple locations separate from the baseband system 16. The baseband system 16 may be connected to the RF subsystems via the network to provide the wireless services, such as CDMA discussed above. Accordingly, in either system, the baseband system 16 serves the RF system 14 and manages the communications and hand-offs for the wireless units 18ₐ-18ₘ.

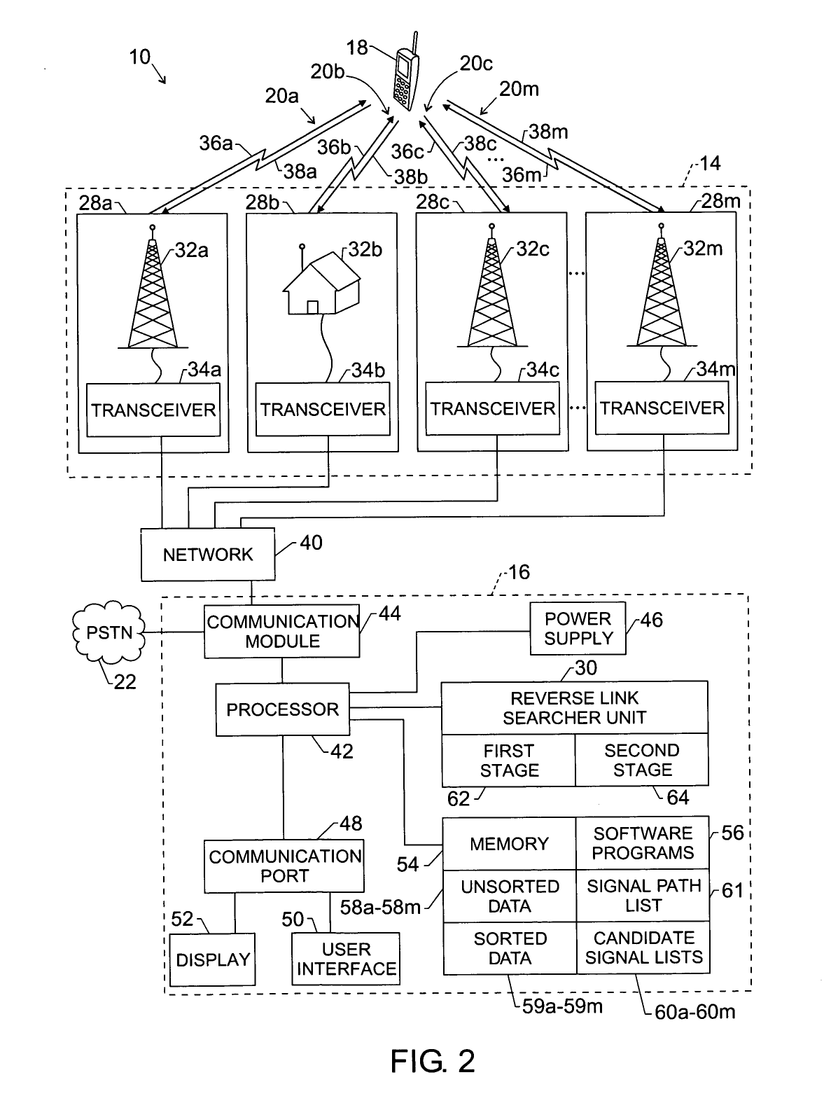

Regardless of the RF system 14 being a distributed or centralized system, the baseband system 16 manages the hand-off process for the wireless units 18ₐ-18ₘ that are connected to the RF system 14. The hand-off process is a technique where signal paths 20ₐ-20ₘ may be transferred from a current RF subsystem to another RF subsystem associated with the baseband system 16 or associated with another base station. The hand-off process may involve changing the signal paths 20ₐ-20ₘ utilized for the connection with the wireless units 18ₐ-18ₘ because other signal paths 20ₐ-20ₘ have been determined to provide stronger signals. The selection of an appropriate signal path for the wireless units 18ₐ-18ₘ is further explained in the exemplary embodiment of a base station 12, as shown in FIG. 2.

In FIG. 2, an exemplary embodiment of a base station that includes a baseband system 16 and an RF system 14 is shown. In this embodiment, the baseband system 16 manages the path selection process for an exemplary wireless unit 18 to determine the appropriate signal paths 20ₐ-20ₘ. The baseband system 16 may utilize a reverse link searcher unit 30 that utilizes reverse portions 38ₐ-38ₘ of the signal paths 20ₐ-20ₘ to determine the appropriate signal paths 20ₐ-20ₘ. In the present embodiment, the reverse link searcher unit 30 may reduce the processing time for searching the signal paths 20ₐ-20ₘ by utilizing a first stage 62 and a second stage 64 to reduce the number of comparison operations utilized to determine the signal paths 20ₐ-20ₘ. As a result, the reverse link searcher unit 30 may enhance the operation of the wireless communications system 10.

Before discussing the reverse link searcher unit 30 in the baseband system 16, however, it is useful to discuss the RF system 14 and the wireless unit 18 in the exemplary wireless communications system 10. As can be seen, the wireless unit 18 establishes signal paths 20ₐ-20ₘ with different antennas 32ₐ-32ₘ that are associated with respective RF subsystems 28ₐ-28ₘ. It should be understood that the RF subsystems 28ₐ-28ₘ may take any suitable form. For example, the RF subsystems 28ₐ-28ₘ may include antennas mounted on a tower, such as shown by the antennas 32ₐ, 32_{c} and 32ₘ, or antennas mounted on a building, such as the antenna 32_{b}. The RF system 14 and RF subsystems 28ₐ-28ₘ may also support multiple technologies, e.g., TDMA, CDMA, FDMA, and GSM, with a separate transceiver unit 34ₐ-34ₘ being dedicated for each technology. Further, the transceiver units 34ₐ-34ₘ may be different sizes to provide different coverage footprints, such as macro, micro, pico, and nano. In addition, as noted above, the RF subsystems 28ₐ-28ₘ may communicate voice and/or data with any suitable wireless unit and may be positioned in a distributed or centralized configuration.

To communicate with the wireless unit 18, the RF subsystems 28ₐ-28ₘ utilize portions of the signal paths 20ₐ-20ₘ, such as forward portions 36ₐ-36ₘ and reverse portions 38ₐ-38ₘ. Each base station 12, or RF subsystem 28ₐ-28ₘ, may be assigned a set of communication channels from a portion of the radio frequency spectrum that is assigned to a particular wireless service. The communication channels may be exchanged between the wireless unit 18 and the RF subsystem 28ₐ-28ₘ via the forward portions 36ₐ-36ₘ and the reverse portions 38ₐ-38ₘ. The forward channels or portions 36ₐ-36ₘ are portions of the signal paths 20ₐ-20ₘ from the base station 12 to the wireless unit 18. For instance, if the system utilizes CDMA, the forward portions 36ₐ-36ₘ may include one or more code channels that are transmitted on pilot channels to the wireless unit 18. The forward portions 36ₐ-36ₘ may be utilized to communicate user and signaling traffic from the base station 12 to the wireless unit 18. The reverse portions 38ₐ-38ₘ are portions of the signal paths 20ₐ-20ₘ from the wireless unit 18 to the base station 12. For instance, if the system utilizes CDMA, the reverse portions 38ₐ-38ₘ may also include one or more code channels. The reverse portions 38ₐ-38ₘ may be utilized to communicate data and signaling traffic from the wireless unit 18 to the base station 12. Through the use of these forward portions 36ₐ-36ₘ and reverse portions 38ₐ-38ₘ, the base station 12 and the wireless unit 18 are able to communicate and maintain the signal paths 20ₐ-20ₘ with each other.

A network 40 may be utilized to provide a communication path between the baseband system 16 and the distributed RF subsystems 28ₐ-28ₘ of the RF system 14. In the base station 12, the RF system 14 and the baseband system 16 may communicate over various layers or protocols and may interoperate over any physical or wireless layer in a Local Area Network (“LAN”), Server or Storage Area Network (“SAN”), Metropolitan Area Network (“MAN”), Wide Area Network (“WAN”), backplane, bus, or the like. Because the RF subsystems 28ₐ-28ₘ may be centralized or distributed, the network 40 may include a variety of types of network architectures to provide communication paths between the RF subsystems 28ₐ-28ₘ and the baseband system 16.

In this example, the baseband system 16 includes a processor 42, such as a microprocessor, that controls many of the functions of the baseband system 16. The baseband system 16 also includes a communication module 42 that is utilized by the processor 42 to communicate via the network 40 to the RF system 14 and to the PSTN 22. Further, the baseband system 16 includes a power supply 46 that delivers power to components of the baseband system 16. The type of power supply 46 may vary depending on the source of the power. For instance, if the baseband system 16 is stored in a cabinet, the power supply 46 may include permanent batteries, replaceable batteries, and/or rechargeable batteries that are used along with an AC adapter so that the device may be plugged into a wall outlet. In addition, the power supply 46 may also include a DC adapter or DC converter to modify the power received from telecommunications lines or other sources that provide DC power.

Various other components may also be coupled to the processor 42 to provide the functionality for the baseband system 16, as discussed above. For instance, the baseband system 16 may include a communication port 48 that is adapted to interact with a user interface 50. The user interface 50 may include buttons, switches, a keyboard, a light pen, a mouse, and/or other input devices, for instance. Also, a display 52 may be coupled to the processor through the communication port 48. The display 52 may include, for example, a liquid crystal display (LCD), a cathode ray tube (CRT), and/or light emitting devices (LEDs).

Because the processor 42 controls the functioning of the baseband system 16, generally under the control of software programming, memory 54 is coupled to the processor 42 to store and facilitate the execution of software programs 56. The memory 54 may include dynamic random access memory (DRAM), static random access memory (SRAM), read-only memory (ROM), CD-ROM's, or other suitable storage devices. As such, the memory 54 may be utilized by the processor 42 to store unsorted data 58ₐ-58ₘ, sorted data 59ₐ-59ₘ, candidate signal lists 60ₐ-60ₘ and a signal path list 61 that are utilized by the software programs 56 along with other units, such as the reverse link searcher unit 30, as discussed below. The unsorted data 58ₐ-58ₘ and sorted data 59ₐ-59ₘ may include information and values that are associated with the signal paths 20ₐ-20ₘ of one of the antennas 32ₐ-32ₘ, such as different signal energies for the different reverse portions 38ₐ-38ₘ. In addition, the candidate signal lists 60ₐ-60ₘ and a signal path list 61 may include sorted signal energies and antenna information that is related to the various signal paths 20ₐ-20ₘ.

Furthermore, the processor 42 may be coupled to the reverse link searcher unit 30. The reverse link searcher unit 30 may be utilized to search the respective signal paths to determine the appropriate signal path based on the signal energies associated with the wireless unit 18. The reverse link searcher unit 30 may be implemented as a software program, which may be a routine or one of the software programs 56, or as a hardware component, such as a field programmable gate array (FPGA), a digital signal processor (DSP), an application specific integrated circuit (ASIC), or a combination of these hardware components. Specifically, the reverse link searcher unit 30 may be implemented in a hybrid FPGA/DSP for 3G3X CDMA2000.

To search for the respective signal paths 20ₐ-20ₘ, the reverse link searcher unit 30 may sort the signal energies E₁-E_{N} associated with the reverse portions 38ₐ-38ₘ on the various source antennas 32ₐ-32ₘ to determine a specific number “n” of the largest signal energies E₁-E_{N}. The reference character “N” may correspond to the number of communication channels or signal paths 20ₐ-20ₘ to be searched on each of the antennas 32ₐ-32ₘ, while reference character “n” may correspond to the number of signal paths 20ₐ-20ₘ in each group of candidate signal lists 60ₐ-60ₘ from the antennas 32ₐ-32ₘ. The comparison of the signal energies E₁-E_{N} becomes more complex and time consuming as the signal energies E₁-E_{N} and the “n” signal paths 20ₐ-20ₘ in the group of candidate signal lists 60ₐ-60ₘ increase. For example, a one-by-one comparison of the signal energies E₁-E_{N} to find the “n” signal energies E₁-E_{N} for each of the candidate signal lists 60ₐ-60ₘ may utilize approximately “n” times “N” comparisons. As such, the processing requirements may be large and consume more time than is allocated to the reverse link searcher unit 30 to perform the comparisons. For instance, with CDMA2000, the reverse link searcher unit 30 may have to determine the appropriate signal path for the users covered within a time interval of about 1.25 ms or less.

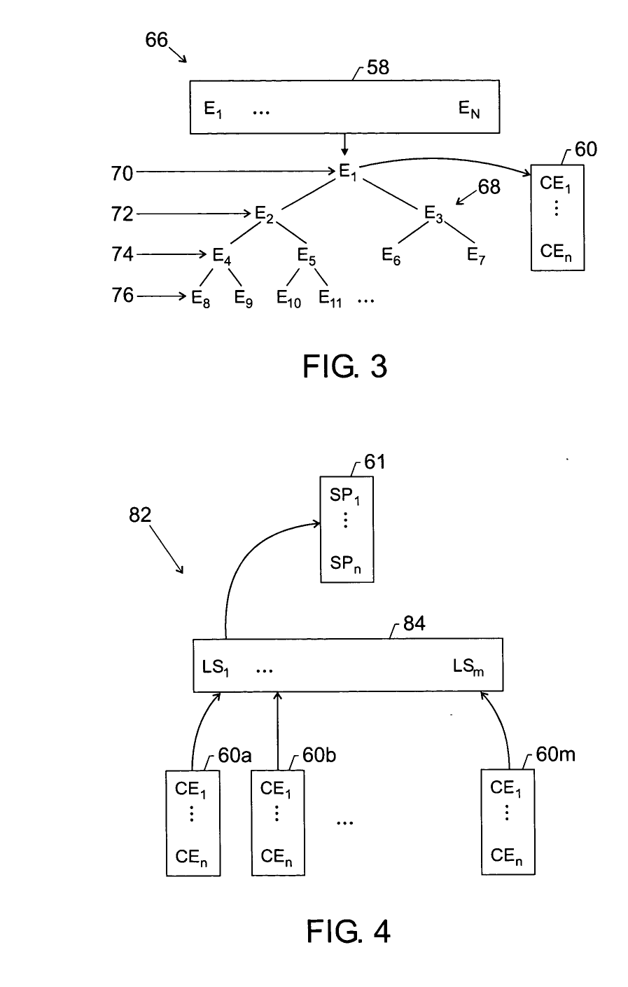

Beneficially, because the number of candidate signal lists 60ₐ-60ₘ is “n,” which may be relatively small, the reverse link searcher unit 30 may include the first stage 62 that sorts the signal energies E₁-E_{N} to determine the candidate signal lists 60ₐ-60ₘ associated with each of the antennas 32ₐ-32ₘ. The signal energies E₁-E_{N} may be a block of data that is in the unsorted data 58ₐ-58ₘ. In the first stage 62, a first sorting algorithm may be utilized to improve the process by reducing the number of comparison operations. For instance, a heapsort algorithm, such as an “n” out of “N” heapsort algorithm, may be utilized to determine the “n” signal energies in each of the candidate signal lists 60ₐ-60ₘ. The first stage 62 of reverse link searcher unit 30 is explained in greater detail below in FIG. 3.

As noted above, multiple antennas 32ₐ-32ₘ are utilized to establish signal paths 20ₐ-20ₘ with the wireless unit 18. The reverse link searcher unit 30 may search these antennas 32ₐ-32ₘ to determine the largest signal energies for the signal path list 61. Accordingly, the candidate signal lists 60ₐ-60ₘ may be obtained from the first stage 62. With the candidate signal lists 60ₐ-60ₘ from each of the antennas 32ₐ-32ₘ, a signal path list 61 may be created by sorting the candidate signal lists 60ₐ-60ₘ from each of the antennas 32ₐ-32ₘ into the signal path list 61 based on largest signal energies. In the second stage 64, a second sorting algorithm may be utilized to improve the process by again reducing the number of comparison operations to provide the signal path list 61 that include the “n” largest signal energies. For instance, a two-level sorting algorithm may be utilized to store the largest signal strengths from each of the candidate signal lists 60ₐ-60ₘ into the signal path list 61. The second stage 64 of reverse link searcher unit 30 is explained in greater detail below in FIG. 4.

Advantageously, by utilizing the first stage 62 and the second stage 64 in the reverse link searcher unit 30, the processing time of the multi-path searching may be reduced as compared to the one-by-one comparison method mentioned above. The processing time may be reduced because the first sorting algorithm, such as a heapsort algorithm, reduces the number of comparison operations that are utilized to sort the signal energies E₁-E_{N} from each of the antennas 32ₐ-32ₘ. In addition, in the software or the hybrid software/hardware implementation of the reverse link searcher unit 30, the method may be an optimized approach that reduces the cost of the first stage 62 of the reverse link searcher unit 30.

In FIG. 3, an exemplary diagram that illustrates the sorting of the signal energies in first stage 62 of the reverse link searcher unit 30 is shown. In this diagram 66, unsorted data 58 may be sorted into sorted data 59 by the first stage 62 of the reverse link searcher unit 30. The unsorted data 58 and sorted data 59 may be representative of the unsorted data 58ₐ-58ₘ and unsorted data 59ₐ-59ₘ that is associated with each of the respective antennas 32ₐ-32ₘ. The unsorted data 58 may include signal energies E₁-E_{N} that represent the signal strengths of the associated signal paths 20ₐ-20ₘ on the various source antennas 32ₐ-32ₘ, as discussed above.

The first stage 62 may include the first algorithm that is utilized to sort the unsorted data 58 into sorted data 59 in an efficient manner. For instance, the sorting process in the first stage 62 may utilize the first algorithm to sort the signal energies E₁-E_{N} into a heap structure, which is referenced as the sorted data 59. If the signal energies are numbers Ei, i=1, 2, . . . , N, the signal energies E₁-E_{N} may be arranged to comply with the relation:
E_{floor(i/2)}≧Eᵢ for 1≦i/2<i≦N.
As such, the signal energies E₁-E_{N} may form a heap structure 68. In this heap structure 68, three of the signal energies E₁-E_{N} are compared on a level-by-level basis. As a result, the largest of the signal energies E₁-E_{N} is placed on the highest level, while the lower of the signal energies E₁-E_{N} are placed on the lower level. The resulting heap structure 68 has E₁ greater than E₂ and E₃, E₂ greater than E₄ and E₅, E₄ greater than E₈ and E₉, and E₅ greater than E₁₀ and E₁₁, etc.

To create the heap structure 68, Nₕₚ comparison operations are performed:

$${N}_{hp} = \frac{N}{2} + \frac{N}{4} + … + \frac{N}{{2}^{{log}_{2} N - 1}} = {\sum }_{k = 1}^{{log}_{2} N - 1} \frac{N}{{2}^{k}} = N - 2$$

In these comparisons, Nₕₚ is the number of comparison operations performed to create the heap structure 68 that is stored in sorted data 59, while k is the number of levels 70-78 in the heap structure 68. Once the heap structure 68 is created, a “retire and promotion” sorting process may be utilized to order the signal energies E₁-E_{N} from largest to smallest within the heap structure 68. Accordingly, to order the heap structure 68, Nᵣₚ comparison operations are performed:

$${N}_{rp} = ( {log}_{2} N - 1 ) \cdot \frac{N}{2} + ( {log}_{2} N - 2 ) \cdot \frac{N}{4} + … + ( {log}_{2} N - k ) ( n - {\sum }_{i = 1}^{i = k - 1} \frac{N}{{2}^{i}} )$$

In the “retire and promotion” sorting process, a first level 70, which may be the highest level of the heap structure 68, may have largest of the signal energies E₁-E_{N}., which may be the signal energy E₁. The signal energy E₁ may be removed from the first level 70 and placed into the candidate signal list 60, which may be a queue that represents any of the candidate signal lists 60ₐ-60ₘ. The signal energies E₁-E_{N} placed into the candidate signal list 60 may be referenced as candidate signal energies CE₁-CEₙ. Once the signal energy E₁ is placed in the candidate signal list 60, the largest of the signal energies E₁-E_{N} on the second level 72 may be compared to determine the signal energy that will replace the signal energy E₁ on the first level 70. Once the largest of the signal energies E₁-E_{N} is removed from the second level 72, it may be placed on the first level 70 of the heap structure 68. This process may continue down the heap structure 68 until one of the signal energies E₁-E_{N} on the fourth level 78 is placed on the third level 76. Then, the process may repeat until “n” signal energies E₁-E_{N} are placed into the candidate signal list 60.

Advantageously, in the “retire and promotion” sorting process, the “n” signal energies E₁-E_{N} in the candidate signal list 60 may be less than the N/2, which is the number of signal paths 20ₐ-20ₘ to be searched on each of the antennas 32ₐ-32ₘ. Even if the “n” signal energies E₁-E_{N} is greater than halve of “N,” the number of the comparison operations Nrp to be performed in the “retire and promotion” sorting process is:

$${N}_{rp} = ( {log}_{2} N - 1 ) \cdot \frac{N}{2} + ( {log}_{2} N - 2 ) \cdot \frac{N}{4} + … + ( {log}_{2} N - k ) ( n - {\sum }_{i = 1}^{i = k - 1} \frac{N}{{2}^{i}} )$$

$$where$$

$$k = ceil ( {log}_{2} n ) , {\sum }_{i = 1}^{i = k - 1} \frac{N}{{2}^{i}} < n \leq {\sum }_{i = 1}^{i = k} \frac{N}{{2}^{i}} .$$

However, with the signal path selection process, the “n” signal energies E₁-E_{N} in the candidate signal list 60 is less than “N/2.” In this situation, the number of the comparison operations Nrp to be performed in the “retire and promotion” sorting process is:
Nᵣₚ=n·(log₂N−1)
with the total number of the generalized heapsort algorithm Nₕₛ being:
Nₕₛ=Nₕₚ+Nᵣₚ=N−2+n·(log₂N−1)
Therefore, with the “n” signal energies E₁-E_{N} being small, the processing complexity increases in an almost linear manner as “N” increases. As a result, the comparison operations approach:
N−2+N·(log₂N−1)≈N·log₂N
Thus, the “retire and promotion” sorting process may reduce the number of comparison operations utilized in determining the largest signal energies E₁-E_{N}.

For example, the one-by-one comparison and selection process utilizes n×N comparison operations, while the “n” out of “N” heapsort algorithm process utilizes N×log₂ N comparison operations. If the “n” signal energies E₁-E_{N} in the candidate signal list 60 is smaller than “N,” which is the number of signal paths 20ₐ-20ₘ to be searched, the “n” out of “N” heapsort algorithm reduces the number of comparison operations as compared to the one-by-one comparison method. Specifically, as shown in Table 1, if “N” is 512 and “n” is 12, then “n” out of “N” heapsort algorithm improves the processing in the first stage 62 by about ten times as compared to the one-by-one comparison algorithm.

TABLE 1
“n” Out of “N” Comparison Operations Processing.

| Algorithms | Number of Compare Operations |
|---|---|
| “n” out of “N” heapsort algorithm | 606 |
| Convention heapsort algorithm | 4608 |
| One-by-one comparison algorithm | 6144 |

From Table 1, it is clear that the “n” out of “N” heapsort algorithm greatly reduces the comparison operations and the associated processing time.

As a specific example, the “n” out of “N” heapsort algorithm may be implemented as source code, which may include C source code. The source code may include a heap creation process that creates the heap structure 68 and a “retire and promote” process that creates the candidate signal lists 60ₐ-60ₘ. For example, the unsorted data 58 may be represented by D_SRCH_DATA[i].SRCH_ENERGY, while the PN offset, which may be used to differential different pilot channels, may be represented by D_SRCH_DATA[i].SRCH_POSI. Also, each of the antennas 32ₐ-32ₘ may be represented by D_SRCH_DATA[i].SEC_ANTENA, while the “n” signal energies E₁-E_{N} in the candidate signal list 60 may be represented by DD_SEARCH_LENGTH. Specifically, the source code for the heap creation process may be:

```
1 = (DD_SEARCH_LENGTH >> 1) +1;
while (l > 1)
{
    temp = D_SRCH_DATA[−−l − 1].SRCH_ENERGY;
    pick_result = D_SRCH_DATA[l − 1];
    i = 1;
    j = 1 << 1;
    while (j <= DD_SEARCH_LENGTH)
    {
        if (j < DD_SEARCH_LENGTH && D_SRCH_DATA[j − 1].
            SRCH_ENERGY
            < D_SRCH_DATA[j].SRCH_ENERGY) ++j;
        if (temp < D_SRCH_DATA[j − 1].SRCH_ENERGY)
        {
            D_SRCH_DATA[i − 1] = D_SRCH_DATA[j − 1];
            j += (i = j);
        }
        else j = DD_SEARCH_LENGTH + 1;
    }
    D_SRCH_DATA[i − 1] = pick_result;
}.
```

The source code for the “retire and promote” process may be:

```
/*only limited operations have been conducted to sort the number
of samples of interest*/
ir = DD_SEARCH_LENGTH;
PER_ANTEN_SORT[(SRCH_ANT_COUNTER − 1) * 12] =
D_SRCH_DATA[0];
for (k = 1; k < 12; k++)
{
    i = 1;
    j = 2;
    temp = D_SRCH_DATA[ir − 1].SRCH_ENERGY;
    pick_result = D_SRCH_DATA[ir − 1];
    −−ir;
    while ( j < ir )
    {
        if (j < DD_SEARCH_LENGTH &&
        D_SRCH_DATA[j − 1].
            SRCH_ENERGY
            < D_SRCH_DATA[j].SRCH_ENERGY) ++j;
        if (temp < D_SRCH_DATA[j − 1].SRCH_ENERGY)
        {
            D_SRCH_DATA[i − 1] = D_SRCH_DATA[j −
            1];
            j += (i = j);
        }
        else j = ir + 1;
    }
    D_SRCH_DATA[i − 1] = pick_result;
    PER_ANTEN_SORT[(SRCH_ANT_COUNTER − 1) * 12 + k]
    = D_SRCH_DATA[0];
}
```

Though the use of source code, the heap creation and the “retire and promote” processes utilize an “n” out of “N” heapsort algorithm to enhance the signal path selection process for the first stage 62 of the reverse link searcher unit 30.

In FIG. 4, an exemplary diagram that illustrates the sorting of candidate signal energies CE₁-CEₙ from the antennas 32ₐ-32ₘ in second stage 64 of the reverse link searcher unit 30 is shown. In this diagram 82, the candidate signal list 60ₐ-60ₘ may be sorted by the second stage 64 of the reverse link searcher unit 30 into the signal path list 61, which may be an ordered queue of candidate signal energies CE₁-CEₙ along with the associated antenna information. The candidate signal energies CE₁-CEₙ may be representative of signal energies E₁-E_{N} from the associated antennas 32ₐ-32ₘ. The second stage 64 of the reverse link searcher unit 30 may utilize a second sorting algorithm, such as a two-level grouping process, to sort the candidate signal energies CE₁-CEₙ within candidate signal lists 60ₐ-60ₘ. From the ordered candidate signal energies CE₁-CEₙ, the second stage 64 may create the signal path list 61.

Because multiple antennas 32ₐ-32ₘ having multiple communication channels may be involved in the path selection process, the candidate signal energies CE₁-CEₙ are sorted to determine the strongest of the signal paths 20ₐ-20ₘ from the associated antennas 32ₐ-32ₘ. As discussed above, if there are “m” antennas involved, then “m” candidate signal lists 60ₐ-60ₘ are obtained from the first stage 62. The signal path list 61 may include the “n” largest candidate signal energies CE₁-CEₙ from the different antennas 32ₐ-32ₘ. With each of the candidate signal lists 60ₐ-60ₘ being sorted in the first stage 62, a second algorithm, such as a “two-level grouping” sorting algorithm, which is discussed below, may be utilized to sort the “n” largest signal energies E₁-E_{N} from the different antennas 32ₐ-32ₘ.

To sort the candidate signal energies CE₁-CEₙ from each of the candidate signal lists 60ₐ-60ₘ, the largest candidate signal energies CE₁-CEₙ may be removed from the respective candidate signal lists 60ₐ-60ₘ and placed into a lead signal list 84 that includes lead signals LS₁-LSₘ, which are the largest candidate signal energies CE₁-CEₙ from candidate signal lists 60ₐ-60ₘ. Then, the lead signal list 84 may be sorted to determine the largest lead signal LS₁-LSₘ within the lead signal list 84. Once the lead signal list 84 is sorted, the largest of the lead signals LS₁-LSₘ may be placed into the signal path list 61, as a first selected signal path SP₁. The next one of the candidate signal energies CE₂-CEₙ may be removed from the candidate signal lists 60ₐ-60ₘ and may replace the lead signal LS₁-LSₘ that was removed from the lead signal list 84. The next one of the candidate signal energies CE₂-CEₙ may be inserted in the place of the lead signal LS₁-LSₘ that was removed or may be placed at the end of the lead signal LS₁-LSₘ. This process may continue until the signal path list 61 has selected signal paths SP₁-SPₙ.

Advantageously, in the “two-level grouping” sorting process, the processing to determine the selected signal paths SP₁-SPₙ in the signal path list 61 is improved over other approaches, such as one-by-one comparison process or the two-level grouping with straight insertion process. For instance, with the “two-level grouping” sorting process, the straight insertion approach is utilized for the first insertion, which requires ½ m² comparison operations. The following comparison operations may be m comparison operations. As a result, N_{TLG} represents the number of comparison and selection operations for the “two-level grouping” sorting process, which is:

$${N}_{TLG} = \frac{1}{2} {m}^{2} + ( n - 1 ) \cdot ( m - 1 )$$

In contrast, N_{SL} represents the number of comparison and selection operations for the straight insertion process, which is:
N_{SL}=½n×m²
Even with the one by one comparison method, N_{OBO} represents the number of comparison and selection operations for the straight insertion process, which is:
N_{OBO}=n²×m.
As such, the “two-level grouping” sorting process reduces the number of comparison operations to reduce the processing time for the second stage 64.

For instance, the number of selected signal paths SP₁-SPₙ is “n,” and the number of candidate signal lists 60ₐ-60ₘ is “m.” As shown in Table 2, if “n” is 12 and “m” is 10, then the “two-level grouping” sorting process may improve the path selection processing in the second stage 64.

TABLE 2
Two-level Grouping Comparison Operations

| Sorting Algorithm | Number Comparison Operations |
|---|---|
| Two-level Grouping Algorithm | 149 |
| Two-level Grouping with Straight | 600 |
| Insertion Algorithm | |
| One by One Comparison Algorithm | 1444 |

From Table 2, it is clear that the “two-level grouping” algorithm is approximately ten times faster than the one-by-one comparison algorithm.

As a specific example, the “two-level grouping” algorithm may be implemented as source code, which may include C source code. The source code may include a lead signal sorting process that creates the lead signal list 84 and a “promotion and replacement” process that replaces the lead signal LS₁-LSₘ in the lead signal list 84. Specifically, the source code for the first lead signal sorting process may be:

```
/*all antenna results final sorting*/
/* group leaders form a board of governors */
for (i = 0; i < SRCH_ANT_COUNTER; i++)
{
    group_leader[i] = PER_ANTEN_SORT[12*i];
    index[i] = 12*i;
}
for (j=1; j<= SRCH_ANT_COUNTER − 1; j++)
    {
        temp = group_leader[j].SRCH_ENERGY;
        pick_result = group_leader[j];
        pick_index = index[j];
        i = j − 1;
        while ( i >= 0 && group_leader[i].SRCH_ENERGY <
        temp)
        {
            group_leader[i+1] = group_leader[i];
            index[i+1] = index[i];
            i−−;
        }
        group_leader[i+1] = pick_result; /*insert it*/
        index[i+1] = pick_index;
    }
/*report*/
SRCH_BEST_ENERGY [0] = (unsigned
int)group_leader[0].SRCH_ENERGY >> 1;
SRCH_BEST_OFFSET [0] = group_leader[0].SRCH_POSI;
SRCH_BEST_OFFSET [0] |= group_leader[0].SEC_ANTENA << 13;.
```

The source code for the “promotion and replacement” process may be:

```
for (k = 1; k < 12; k++)
{
    group_leader[0] = PER_ANTEN_SORT[index[0] + 1];
    index[0] = index[0] + 1;
    temp = group_leader[0].SRCH_ENERGY;
    pick_result = group_leader[0];
    pick_index = index[0];
    i = SRCH_ANT_COUNTER − 1;
    while ( i > 0 && group_leader[SRCH_ANT_COUNTER −
    i].SRCH_ENERGY
        > temp)
    {
        group_leader[SRCH_ANT_COUNTER − 1 − i] =
            group_leader[SRCH_ANT_COUNTER − i];
        index[SRCH_ANT_COUNTER − 1 − i] =
            index[SRCH_ANT_COUNTER − i];
        i−−;
    }
    group_leader[SRCH_ANT_COUNTER − i − 1] = pick_result;
    /*insert it*/
    index[SRCH_ANT_COUNTER − i − 1] = pick_index;
    /*report the results*/
    SRCH_BEST_ENERGY [k] = (unsigned
    int)group_leader[0].SRCH_ENERGY
        >> 1;
    SRCH_BEST_OFFSET [k] = group_leader[0].SRCH_POSI;
    SRCH_BEST_OFFSET [k] |= group_leader[0].SEC_ANTENA
    << 13;
}.
```

From the processes, the selected signal paths SP₁-SPₙ in the signal path list 61 may be associated with the associated PN offset and antenna, which are represented by the SRCH_BEST_ENERGY [k] and the SRCH_BEST_OFFSET [k]. Though the use of the lead signal sorting process and the “promotion and replacement” process, the second stage 64 of the reverse link searcher unit 30 may minimize the comparison operations to improve the processing time in the signal path selection process.

It should be understood that the reverse link searcher unit 30 is merely an example of a hardware device or routine that may be designed using the techniques described herein. Indeed, while the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims. Consequently, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A device for searching signal paths comprising:
a first stage configured to sort a plurality of signal energies into one of a plurality of ordered candidate signal lists associated with one of a plurality of antennas based on the strength of the plurality of signal energies; and
a second stage configured to sort the plurality of ordered candidate signal lists into a signal path list that is ordered based on the strength of the plurality of signal energies in the plurality of ordered candidate signal lists.

2. The device, as set forth in claim 1, wherein the first stage comprises a heapsort algorithm.

3. The device, as set forth in claim 2, wherein the heapsort algorithm comprises an “n” out of “N” heapsort algorithm.

4. The device, as set forth in claim 3, wherein the “n” out of “N” heapsort algorithm comprises a heap creation process that creates a heap structure from the plurality of signal energies and a retire and promote process that creates each of the plurality of ordered candidate signal lists.

5. The device, as set forth in claim 1, wherein the second stage comprises a sorting algorithm.

6. The device, as set forth in claim 5, wherein the sorting algorithm comprises a two-level grouping algorithm.

7. The device, as set forth in claim 6, wherein the two-level grouping algorithm comprises a lead signal sorting process that creates a lead signal list from the largest of the plurality of signal energies in each of the plurality of ordered candidate signal lists and a promotion and replacement process that replaces one of a plurality of lead signals that is placed into the signal path list with another of the plurality of signal energies from one of the plurality of ordered candidate signal lists.

8. A base station comprising:
a plurality of radio frequency systems;
a baseband system coupled to the plurality of radio frequency systems and having a reverse link searcher configured to:
order a plurality of signal energies into one of a plurality candidate signal lists for each of the plurality of radio frequency systems based on the strength of the plurality of signal energies; and
order the plurality of candidate signal lists into a signal path list based on the strength of the plurality of signal energies in the plurality of candidate signal lists.

9. The base station, as set forth in claim 8, wherein the reverse link searcher comprises a hybrid device having a field programmable gate array and a digital signal processor.

10. The base station, as set forth in claim 8, wherein the reverse link searcher comprises a digital signal processor.

11. The base station, as set forth in claim 10, wherein the reverse link searcher comprises a “n” out of “N” heapsort algorithm that is a software routine utilized by the digital signal processor to order the plurality of signal energies.

12. The base station, as set forth in claim 10, wherein the reverse link searcher comprises a two-level grouping algorithm that is a software routine utilized by the digital signal processor to order the plurality of candidate signal lists.

13. A wireless communications system comprising:
at least one wireless unit;
at least one radio frequency system having a plurality of antennas adapted to communicate with the at least one wireless unit; and
a baseband system having a processor and a reverse link searcher, the reverse link searcher comprising:
a first stage configured to sort a plurality of signal energies based on the strength of each of the plurality of signal energies and create one of a plurality of candidate signal lists having a plurality of ordered candidate signal energies associated with one of the plurality of antennas; and
a second stage configured to sort the plurality of candidate signal lists into a path selection list based on the strength of each of the plurality of candidate signal energies.

14. The system, as set forth in claim 13, wherein the at least one radio frequency system communicates with the at least one wireless unit via a code division multiple access system.

15. The system, as set forth in claim 14, wherein the at least one radio frequency system comprises a structure on which the plurality of antennas reside.

16. The system, as set forth in claim 15, wherein the structure comprises a tower.

17. The system, as set forth in claim 15, wherein the structure comprises a building.

18. The system, as set forth in claim 13, wherein the at least one wireless unit comprises at least one portable computer system.

19. The system, as set forth in claim 13, wherein the at least one wireless unit comprises a cellular telephone.

20. The system, as set forth in claim 13, wherein the at least one wireless unit comprises a vehicle having at least one of a mobile telephone and a navigation system.

21. A method of searching comprising:
sorting a plurality of signal energies into one of a plurality of ordered candidate signal lists based on the strength of the plurality of signal energies; and
sorting the plurality of ordered candidate signal lists into a signal path list that is ordered based on the strength of the plurality of signal energies in the plurality of ordered candidate signal lists.

22. The method, as set forth in claim 21, comprising the act of providing the path selection list to a processor for selecting a signal path for a connection with a wireless unit.

23. The method, as set forth in claim 21, wherein the sorting the plurality of signal energies into the one of the plurality of candidate signal lists comprises utilizing an “n” out of “N” heapsort algorithm.

24. The method, as set forth in claim 21, wherein the sorting the plurality of candidate signal energies into the path selection list comprises utilizing a two-level grouping sorting algorithm.
